(19) United States
(12) Patent Application Publication
(10) Pub. No.: US 2015/0006334 A1
(43) Pub. Date: Jan. 1, 2015

(54) VIDEO-BASED, CUSTOMER SPECIFIC, TRANSACTIONS

(71) Applicant: International Business Machines Corporation, Armonk, NY (US)

(72) Inventors: Ajay K. Behuria, Bentonville, AR (US); James E. Bostick, Cedar Park, TX (US); John M. Ganci, JR., Cary, NC (US); Shashank Katare, Nagpur (IN); Shuvamoy Saha, Bentonville, AR (US); Craig M. Trim, Sylmar, CA (US)

(21) Appl. No.: 13/928,121

(22) Filed: Jun. 26, 2013

(51) Int. Cl. G06Q 30/06

(52) U.S. Cl. CPC G06Q 30/0643
USPC 705/27.2

(57) ABSTRACT

A method and system allows a user to select clothing displayed in a video, while the video is playing, have an avatar displayed to them which allows the user to see how they would look in the selected clothing based upon the user's proportions and the clothing measurements, and make a purchase of the clothing depicted on the avatar.

### FIELD OF THE INVENTION

This application generally relates to computers and, more particularly, on-line computer managed transactions for purchase of goods.

### BACKGROUND

Product placement in movies, television programs and video production are a recognized way of increasing sales. However, to be effective, the product or its logo must be highly recognizable and/or prominently placed. This works well for automobiles, soft drinks and products sporting recognizable logos, but is not generally effective for items where no such product indicators exist. Sometimes the express mention of a product can have some effect, but this cannot be done too often without affecting the flow of what is being watched or brazenly seeming like an advertisement. In addition, the foregoing product placement approach is better suited items of broad interest like cars, food and drink, and sporting equipment and is not well suited to items subject to more individualized factors such as clothing, which does not only rely upon look, but also fit.

### SUMMARY

We have developed a way to allow product placement to be used for clothing so that viewers of programming can identify clothing items of interest being worn within the programming, while watching the programming, can see how they will look in that clothing, and can make a purchase of that clothing in a way that reduces the risk that the clothing will not fit upon receipt.

One aspect of the invention involves a method including receiving an indication that a viewer of a video stream has selected a tagged area of the video corresponding to an article of clothing appearing in the video while the video is playing. The method further involves accessing storage and retrieving, using a computer, i) stored information needed to construct an avatar for the viewer dimensioned in proportion to physical dimensions of the viewer based upon an avatar identifier for the viewer, and ii) sizing information regarding the article of clothing corresponding to the tagged area that is sufficient to allow the article of clothing to be displayed on the avatar, and appear to fit the avatar in proportion to how a physical specimen of the article of clothing would fit the viewer. The method also involves displaying to the viewer the avatar for the viewer wearing the proportionally fitted article of clothing.

Another aspect of the invention involves an apparatus. The apparatus includes an Enterprise System Bus (ESB) platform including a processor, memory, tag-related storage and avatar-related storage. The tag-related storage includes information stored therein correlating selectable areas in a video with items of clothing appearing in the video. The avatar-related storage includes information stored therein, provided by a specific user and representing the specific user's actual physical measurements, that is usable by the ESB platform to construct an avatar for the specific user that is proportionally dimensioned to the actual physical measurements. The ESB platform is constructed to, in response to receiving an indication that the specific user has made a selection of a specific selectable area of the video, (i) retrieve details regarding an item of clothing corresponding to the specific selectable area of the video based upon the information stored in the tag related storage, (ii) retrieve the information from the avatar-related storage, (iii) use the details and the retrieved information to construct a clothed avatar for the specific user with the clothed avatar wearing the item of clothing such that a depicted version of the item of clothing on the avatar will fit the avatar in proportion to how the item of clothing will fit the actual physical measurements of the specific user, and (iv) display the clothed avatar to the specific user.

The advantages and features described herein are a few of the many advantages and features available from representative embodiments and are presented only to assist in understanding the invention. It should be understood that they are not to be considered limitations on the invention as defined by the claims, or limitations on equivalents to the claims. For instance, some of these advantages are mutually contradictory, in that they cannot be simultaneously present in a single embodiment. Similarly, some advantages are applicable to one aspect of the invention, and inapplicable to others. Thus, this summary of features and advantages should not be considered dispositive in determining equivalence. Additional features and advantages of the invention will become apparent in the following description, from the drawings, and from the claims.

### BRIEF DESCRIPTION OF THE DRAWINGS

FIG. 1 illustrates, in simplified form, a representative example configuration employing our approach;

FIG. 2 shows, in simplified form, a sequence of video frames;

FIG. 3 shows the frames of FIG. 2 with areas roughly corresponding to three articles of the player's clothing specified as selectable areas;

FIG. 4 shows, in simplified form, an aspect of the clothing-related portion of the ESB related to tagging;

FIG. 5 illustrates, in simplified form, certain avatar-related aspects of the ESB;

FIG. 6 illustrates, in simplified form, one representative example of the culmination of the operation of the ESB 108 as described herein; and

FIGS. 7A-7C illustrate, in simplified flow chart form, the major steps involved in our approach.

### DETAILED DESCRIPTION

In simplified overview, we have developed an approach whereby a person with an interactive video display device, such as an interactive television, gaming console, computer, or other device, can view a video stream, which, as used herein, is intended to mean and encompass motion picture, television (cable or broadcast), on-line video (streaming or stored), and select one or more items of clothing worn by a character in the video stream, view an avatar of themselves (proportioned as they are) wearing the appropriate size of that clothing so that they can see how it will fit, and initiate a purchase of that clothing if they choose.

More specifically, our approach uses an Enterprise Service Bus (ESB) approach to bring together two disparate technologies, video stream provision and virtual fitting room technology, to advantageous effect.

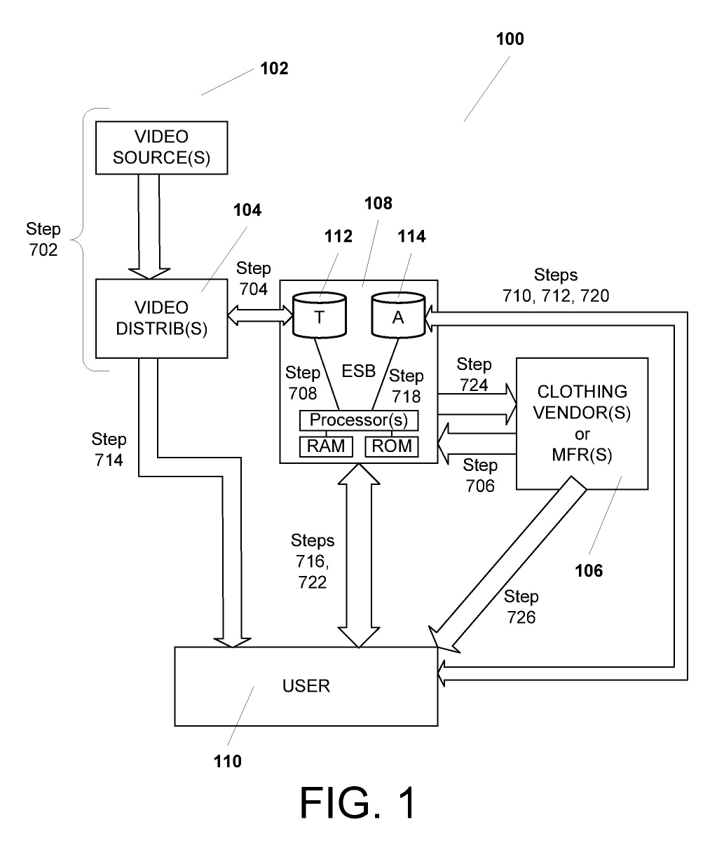

FIG. 1 illustrates, in simplified form, a representative example configuration 100 employing our approach. As shown, the configuration includes one or more video source(s) 102, one or more video distributor(s) 104, one or more clothing vendor(s) or manufacturer(s) 106, and an ESB platform 108.

The video source(s) 102 are the sources for the video content that a user 110 may view. Depending upon the particular implementation, the video content stream could encompass motion pictures, television programs, sporting events, training videos, or any other video programming via which one or more clothing vendor(s) or manufacturer(s) 106 might wish to make sales of their goods. The video distributor(s) 104 are the entities that directly provide video content streams to users and may include cable, satellite and broadcast television networks, internet video content providers, etc.

The ESB platform 108 is the heart of the approach because it is what brings together these other technologies and includes, as will be described in greater detail below, storage 112 containing tag-related information and storage 114 containing avatar-related information. Note here that the storage 112, 114 can be physically part of the same storage device or device array or they can be entirely separate—location and arrangement of the physical devices in which they are located is irrelevant to understanding the construction and operation of the arrangement described herein.

Video-Related Aspects

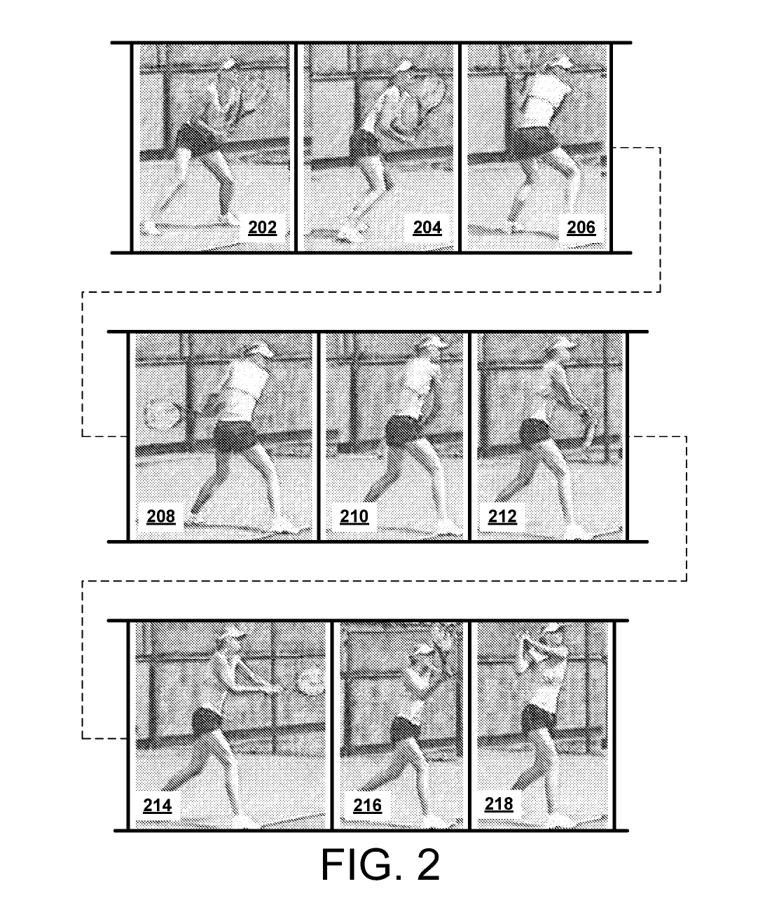

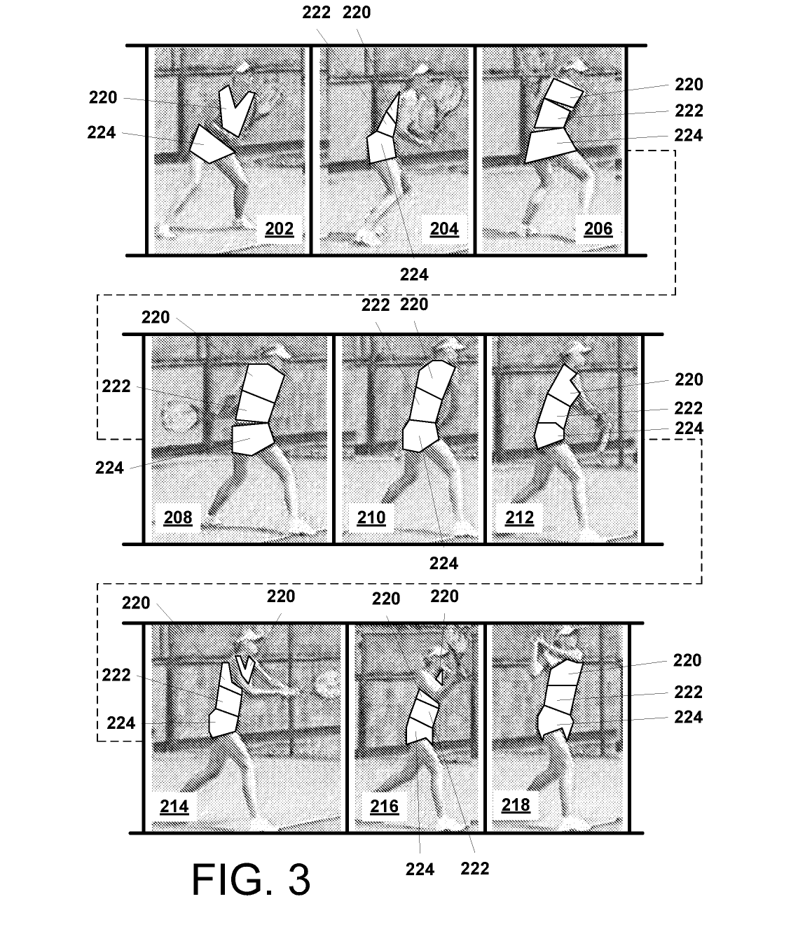

On the video side, the approach relies upon the tagging of the video content, either by the video source(s) 102 or video distributor(s) 104. “Tagging” involves denoting one or more areas as selectable and associating certain information with each such area. For example, FIG. 2 shows, in simplified form, a sequence of frames 202, 204, 206, 208, 210, 212, 214, 216, 218 from video of a tennis player hitting a backhand. FIG. 3 shows the frames 204, 206, 208, 210, 212, 214, 216, 218 of FIG. 2 with areas 220, 222, 224, respectively roughly corresponding to three articles of the player's clothing: a half shirt top, an undershirt and tennis shorts, specified as selectable areas. The delineation of these areas would not be visible to the viewer while watching, but are configured as selectable by a viewer, for example using a mouse, remote control device or other selection mechanism. Each of the areas has information associated with it so that selection of a particular area acts as a pointer to particular associated information maintained by the ESB 108. Thus, as shown, the selection of one area 220 while viewing will invoke the information for the half shirt top, selection of a different area 222 while viewing will invoke the information for an under shirt, and selection of another area 224 while viewing will invoke the information for the tennis shorts.

Depending upon the particular implementation, the information associated with the area can be, for example, a direct Internet Protocol (IP) address for information maintained by the ESB 108, or it can be other information that can be passed to the ESB 108 by a generic routine. The important aspect being that the selection results in receipt by the ESB 108 of information that allows the ESB 108 to equate the user's selection with the particular item of clothing selected, not the specific information passed or the way it is passed to the ESB 108.

In this regard, it is to be noted that, with some implementations, the ESB 108 can be part of or associated with a video distributor 104 (e.g. they may be the same entity or be owned by the same entity). In some such implementation cases, tagging of the video may be performed by the ESB 108 instead of by the video source(s) or distributor(s). It is not important or critical what entity performs the tagging, it is only important that the tagging of the video occur.

There are numerous ways to actually accomplish the tagging of the video and any suitable way is appropriate. For completeness, representative examples of some approaches for tagging video for use as described herein include, but are not limited to, those described in U.S. Pat. Pub. 2012/0072420, U.S. Pat. Pub. 2011/00162002, U.S. Pat. Pub. 2010/0312596, U.S. Pat. Pub. 2010/0154007, U.S. Pat. Pub. 2009/0092374, U.S. Pat. Pub. 2008/0126191, U.S. Pat. Pub. 2008/0046956, and U.S. Pat. Pub. 2008/0034295, as well as U.S. Pat. No. 8,321,896, all of which are incorporated herein by reference as if fully set forth herein.

Clothing-Related Aspects

On the clothing side, the approach relies upon users creating avatars for themselves that are accurately proportionate to each user's own physical dimensions.

In a similar vein, for each tagged piece of clothing in each video, one or more clothing vendors (or alternatively the manufacturer or some surrogate) must provide to the ESB 108 the accurate measurements for that clothing in different sizes and, ideally, several representations of that clothing from different views. The purpose for this is so that the ESB 108 can maintain a virtual fitting room, via which a user can see just how the tagged clothing they select will look on them. Again, any suitable approach for creating and maintaining accurate user avatars and a virtual fitting room can be used.

With some implementations, the approach described herein can be part of a subscription service. As a result, each user who might wish to use this particular aspect can create an avatar specific to them, which will have an associated avatar identifier, so that the user can merely identify themselves as one of a limited number of possible persons at that subscriber location and the avatar identifier for that person can be used to retrieve the correct avatar-related information when required.

Where the approach is not part of a subscription service, the approach can be similar, but the user may have to establish a unique avatar identifier when the information necessary for creation of the avatar is initially obtained. In this way, when required, they can provide that unique avatar identifier which can then be used to retrieve the correct avatar-related information.

There are numerous ways for constructing both the avatars and virtual fitting room type environments. For completeness, some representative examples include the approaches described in U.S. Pat. Pub. 2010/0030578, U.S. Pat. Pub. 2009/0158170, and U.S. Designating PCT Publications WO 2011/0143113 and WO 03/0034303 (all of which are incorporated herein by reference in their entirety). Additional suitable examples include approaches described in Patent Publications GB2488237, EP1959394, and the approaches described in Cheng, “A 3D Virtual Show Room for Online Apparel Retail Shop”, Proceedings: APSIPA ASC 2009: Asia-Pacific Signal and Information Processing Association, 2009 Annual Summit and Conference: pp. 193-199 (2009), and Furukawa, “3D Clothes Modeling from Photo Cloned Human Body”, Lecture Notes in Computer Science Volume 1834, pp 159-170 (2000).

The ESB Related Aspects

The ESB 108 is the key to our approach and binds the video and clothing-related aspects together. Advantageously, by using the ESB 108 with the instant approach to decouple the tag from the information it would be tide to, the tagging in the video becomes much more dynamic because, over time, whatever is associated with the tags by the ESB 108 can be changed without changing the video at all. This is a significant improvement giving a much longer “shelf life” to the tagging. The ESB 108 is a computerized systems made up of one, and likely multiple processors, storage (in terms of RAM, ROM, program storage and data storage), which includes at least the tag-related information storage 112 and the avatar-related information storage 114, as well as input-output (I/O) interfaces through which communication between the ESB 108 and other elements described herein can be accomplished. Programming for operation of the ESB 108 is stored in the program storage and executed by the processor(s) to, inter alia, accomplish the functions described herein, which include tag-related operations and avatar-related operations. Each will be now discussed.

Tag-Related Operations

With reference to FIGS. 1 and 3, while a user 110 is viewing a program, their selection of an area 220, 222, 224, results in communication with the ESB 108 and transfer to the ESB 108 of the tag-related information for the area selected. Depending upon the particular implementation, the program can continue playing, it can temporarily pause (for example, using pause and selection features present in many televisions and cable boxes) and it bring up a new screen or a partial screen in part of the viewing area (for example, the well known “picture-in-picture” approach), or it can continue playing while a partial screen opens in part of the viewing area (for example, using the well known computing concept of “windowing”).

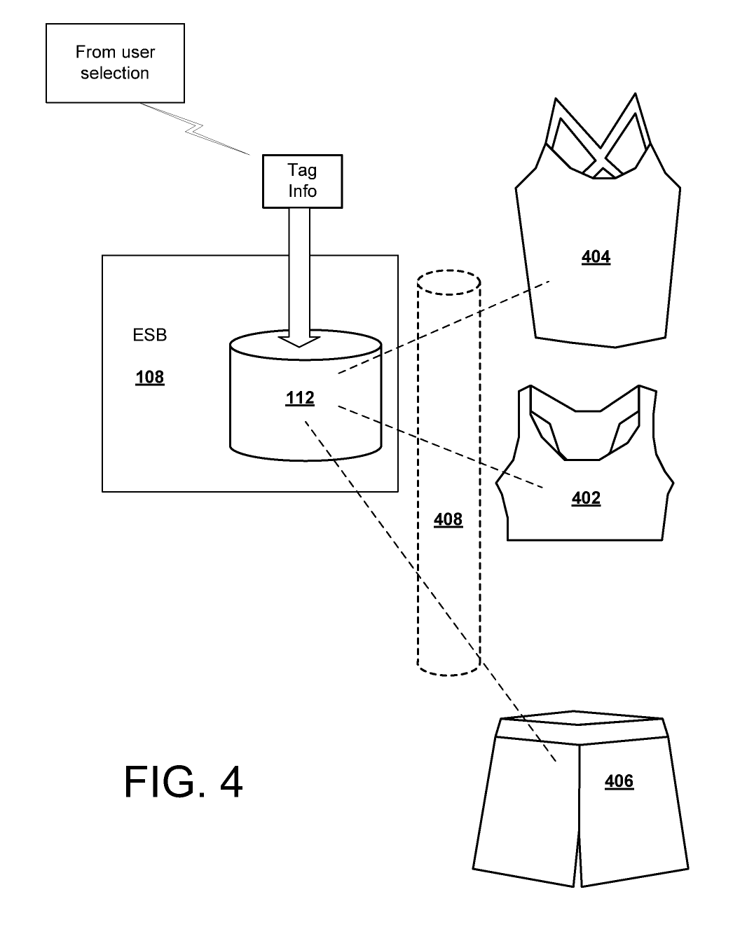

Referring to FIG. 4, which shows, in simplified form, an aspect of the clothing-related portion of the ESB 108 related to tagging. As mentioned above, the ESB 108 provides the dynamic connection between the tagging and the information to which selection of a particular tagged area relates. Upon receipt, of a particular selection, the selection causes the ESB 108 to use the selection to access the tag-related information storage 112 and retrieve information relating to the particular clothing corresponding to the selected area 220, 222, 224. For example, as noted above, selection of one area 220 results in transfer of information to the ESB 108 which will allow the ESB 108 to recognize the selection as relating to the half shirt top 402, selection of a another area 222 will allow the ESB 108 to recognize the selection as relating to the under shirt 404, and selection of yet another area 224 will allow the ESB 108 to recognize the selection as relating to the tennis shorts 406.

Depending upon the particular implementation, there are different options for the ESB 108. Based upon the selection, (i) it can directly retrieve from the storage 112 all of the relevant information about the article of clothing in terms of price, sizes, colors, patterns and actual dimensions that will allow for accurate portrayal of that item of clothing to the user 110 on a user-specific avatar. Alternatively, (ii) it can optionally retrieve the relevant information indirectly via a further link to another database 408, maintained by the ESB 108, the manufacturer(s) or the vendor(s), from which that item-specific information can be obtained, and retrieve it. Advantageously, as noted above, with this approach, the dynamic separation between the tagging and the information which will be provided in response to selection of a tagged area means that the manufacturers and/or vendors and/or pricing can more easily and dynamically be changed over time, or, in implementations where the manufacturer or vendor maintains the database, the manufacturer or vendor can modify sizing or dimensional data, as well as pricing, color and pattern information as desired without involving the ESB 108, which will simply retrieve whatever information is present in the storage 112 in that regard at the time of access.

In addition, a further advantage to this decoupling approach is that different manufacturer(s) or vendor(s) can be used for different regions for the same selection. Thus, a tag in a video corresponding to a particular item, although itself static, can be used by the ESB 108, in combination with information the ESB 108 has about the user 110, to select from among multiple different manufacturer(s) or vendor(s) for that same item. For example, selection of one area 220 might result in identification of one manufacturer or vendor if the user 110 is in the Eastern US, a different manufacturer or vendor if the user 110 is in the Western US, and yet another different manufacturer or vendor if the user 110 is in Europe or the Far East.

Avatar-Related Operations

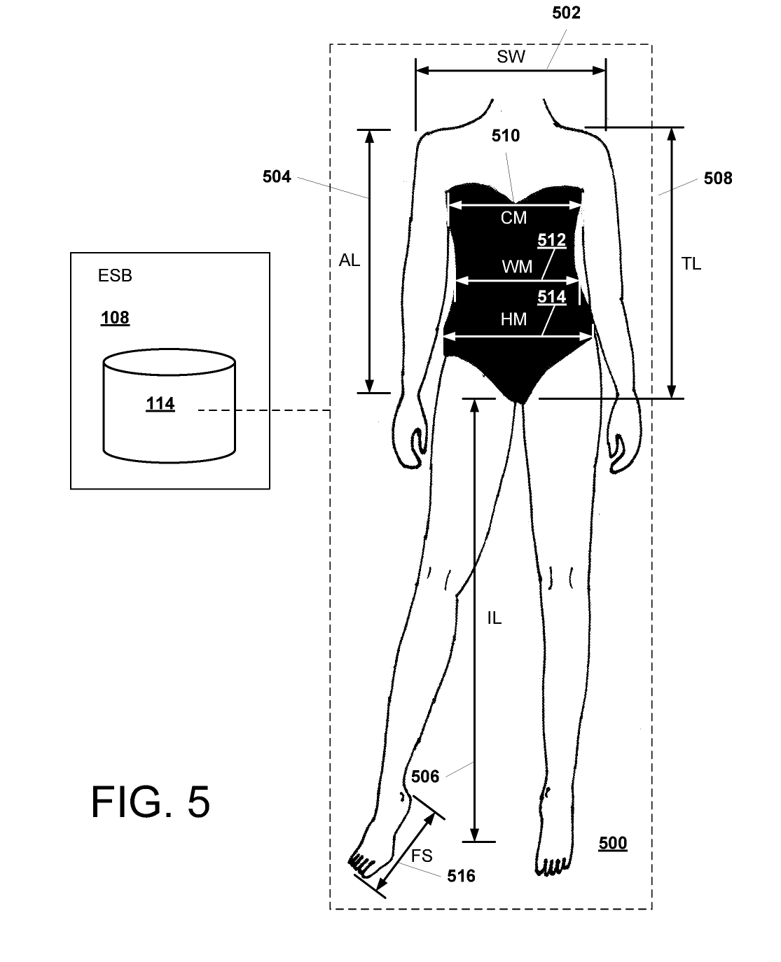

In addition, the ESB 108 will also access the avatar-related information storage 114 which, directly or indirectly, contains dimensional information necessary to construct a user-specific avatar 500 that is proportioned like the user for use in a virtual fitting room as described above. FIG. 5 illustrates, in simplified form, certain avatar-related aspects of the ESB 108 in this regard. For example, as shown in FIG. 5, the dimensional information maintained in the avatar-related information storage 114 can include, for example, shoulder with (SW) 502, arm length (AL) 504, inseam length (IL) 506, torso length (TL) 508, chest measurement(s) (CM) 510, waist measurements (WM) 512, hip measurements (HM) 514 and foot size (FS) 516. In general, all of this information will have previously been obtained by the ESB 108 from the user 110, either directly from the user 110, or via some surrogate, which can include a clothing vendor, a clothing manufacturer or some other third-party, using any suitable approach for doing so, including those described above in the incorporated references, the entity and way by which the ESB 108 obtains the user's dimension information being one of design choice and unimportant to understanding the approach described herein. Moreover, advantageously, with this approach, once the ESB 108 has the initial information, a vehicle can easily set up via which the user 110 can update their dimensional information as desired, for example, if they gain or lose weight or their proportions change due to exercise, sickness, or other events. In this manner, if the ESB 108 has the most current information for the user 110, the accuracy of the fit at the time can be more closely replicated.

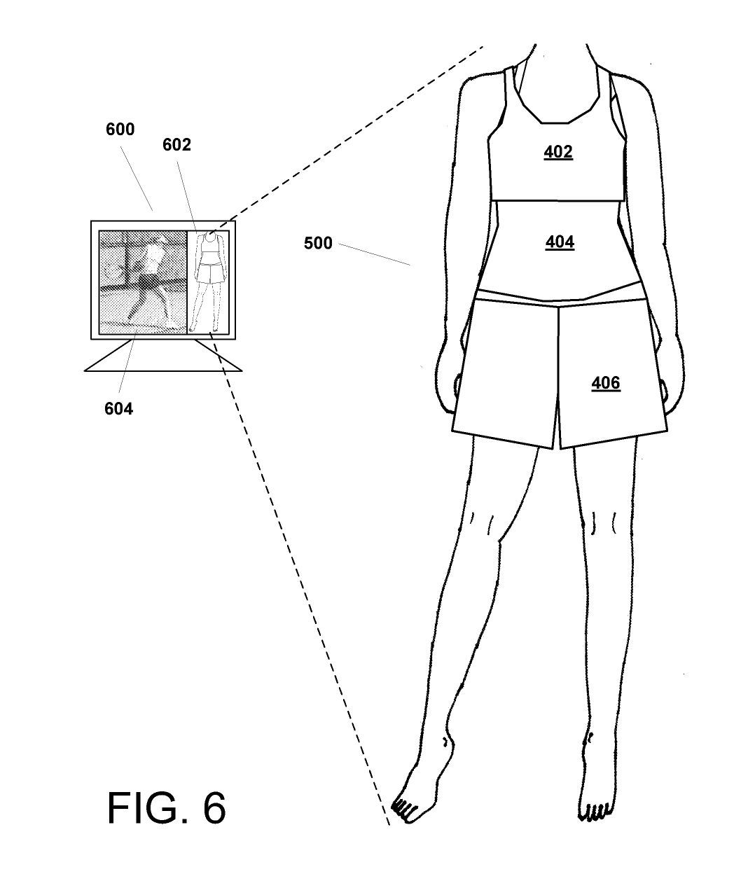

FIG. 6 illustrates, in simplified form, one representative example of the culmination of the operation of the ESB 108 as described herein. As shown in the example of FIG. 6, the ESB 108 uses the foregoing information to depict the avatar 500, in a part 602 of the device 600 on which the user 110 is viewing the program 604, wearing the clothes corresponding to the selection to the user 110 in a way that corresponds to how the clothes will fit on the user 110. In other words, if a selected item of clothing is only available in a larger size and the user 110 is petite in size, the clothing can be shown as overly large on the avatar 500. By way of representative example, and as shown in FIG. 6, the lower portion of the half shirt top 402 is slightly larger in dimension then the avatar 500 and, thus is depicted as hanging on the avatar 500 instead of being more form fitting. Because the avatar 500 dimensions and half shirt top dimensions are both proportional to the actual dimensions of the user 110 and clothing, the user 110 can expect a similar hanging fit when wearing the actual item. Thus, the user 110 would be able to see this and determine if the depicted fit of that item of clothing is acceptable. Similarly, if the selected item of clothing is too small, it may be depicted as stretched and distorted on the avatar 500 to show that it would not fit well either. In some implementations, if other colors or patterns are available for the item than appear in the video, they can be presented so that the user can select from among the available color(s)/pattern(s) of the items as well. Similarly, with some implementations, the user can be allowed to override the automatic size selection and select, for example a larger size, because, for example, they intend to wear the selected item over some other bulkier item of clothing or because they prefer a different (looser/tighter, longer/shorter, wider/narrower) fit.

Advantageously, and alternatively, with some implementations, this same approach can be used to identify post-purchase alterations that may need to be done (and can be done by the manufacturer or vendor) to any purchased item(s) prior to shipment to the user, or it can be used for “made to measure” clothing so that the user can see how they will look before the selected clothing is even manufactured. In the latter case, it can be possible for the user to specify specific modifications they prefer in the foregoing regard, like slightly longer length in sleeves or pant legs than typical, or request a little extra room in certain areas. Thus, for example, with such implementations, in the circumstance shown in FIG. 6, it would be possible for the user to specify that they want the half shirt top 402, but it needs to be altered to take it in at the bottom edge so as to conform to the user's 110 dimension in that area.

As noted above, the outfitted avatar 500 can then be shown to the user 110 (then and there or after the program has concluded, depending upon the particular implementation) in any appropriate or known manner, including those described above, and the user 110 can decide whether or not to purchase the item.

If the user 110 chooses to purchase an item of clothing, depending upon the particular implementation, they can indicate that choice, for example using any known manner, and, depending upon the particular implementation, the ESB 108 can then prompt the user 110 for payment information which it can relay to the relevant vendor or manufacturer. Alternatively, other approaches can be used. For example, if the user 110 is a subscriber to a service of which the ESB 108 is a part, the charge can be incorporated into the service supplier's next bill, the ESB 108 can set up a connection between the user 110 and the particular vendor or manufacturer so that the user 110 can provide payment directly to the vendor or manufacturer, or it can provide the user's billing information to the vendor or manufacturer who then bills the user 110 directly.

Upon receipt or approval of payment, the vendor or manufacturer can then ship the purchased clothing directly to the user 110.

Advantageously, it should be recognized that the user 110 need not be aware of who the vendor or manufacturer may be and, in some cases, where multiple items of clothing are selected for purchase and come from multiple vendors or manufacturers, the actual shipment can be sent to the user 110 via an order fulfillment/packaging entity so that the user only receives a single shipment of all the purchased items together.

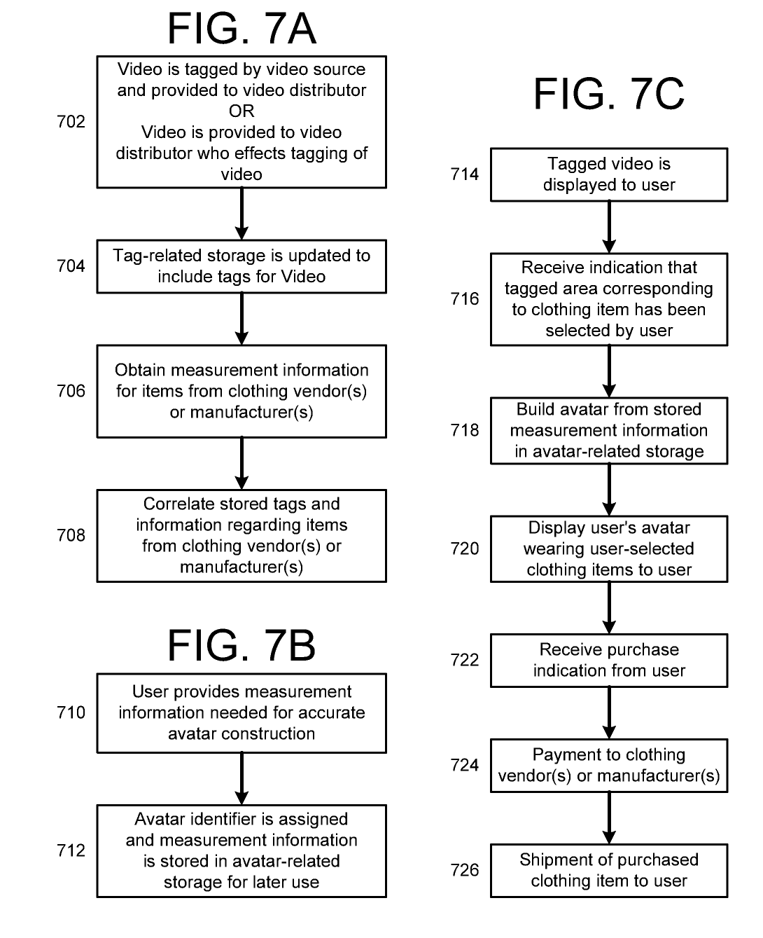

FIGS. 7A-7C illustrate, in simplified flow chart form, the major steps involved in our approach. It is to be understood that the steps described in FIG. 7A can be performed at any time, i.e. before, during (in whole or part) or after, the steps described in FIG. 7B. Likewise, steps described in FIG. 7B can be performed at any time, i.e. before, during (in whole or part) or after, the steps described in FIG. 7A. With that in mind, the processes depicted in these figures will now be described in conjunction with FIG. 1, to illustrate I/O communications among the various entities involved in aspects of the process.

Referring now to FIG. 7A in conjunction with FIG. 1, this part of the process begins with a video being tagged as described above (Step 702). As noted previously, the tagging can be performed by the video source, or by the video distributor following receipt from the video source. The tag-related storage 112 is then updated to reflect the tags contained in the video for clothing therein (Step 704). Based upon the clothing tagged, measurement information for the items of clothing that have been tagged are obtained from clothing vendor(s) or manufacturer(s) (Step 706). The stored tags and measurement information are then correlated (Step 706), which may optionally include correlating multiple vendor(s) or manufacturer(s) to each item if regional distinctions are desired.

Referring now to FIG. 7B in conjunction with FIG. 1, this part of the process begins with a user providing their measurement information so that a proportional avatar can be constructed when needed (Step 710). An avatar identifier is assigned and the measurement information is stored in avatar-related storage 114 for later use (Step 712).

At some point after the steps of FIGS. 7A & 7B are completed, the process of FIG. 7C can proceed.

Referring now to FIG. 7C in conjunction with FIG. 1, this part of the process begins with the tagged video being displayed to a user (Step 714). At some point, the user selects a tagged area for an item of clothing and an indication of that is received by the ESB 108 (Step 716). Based upon an identification of the user (or receipt of an avatar identifier), measurements for the item of clothing selected, and the measurement information stored in the avatar-related storage corresponding to the user, an avatar of the user wearing the selected item of clothing is built such that it proportionally depicts the clothing on the avatar (Step 718). The clothed avatar is then displayed to the user (Step 720). If the user likes what they see, the user 110 can give an indication that they want to purchase the item of clothing, which is received by the ESB 108 (Step 722). Payment information can then be conveyed to the relevant vendor or manufacturer (Step 724), who can then effect shipment of that clothing item to the user 110 (Step 726).

It should be understood that the description (including the figures) is only representative of some illustrative embodiments. For the convenience of the reader, the above description has focused on a representative sample of all possible embodiments, a sample that teaches the principles of the invention. The description has not attempted to exhaustively enumerate all possible variations. That alternate embodiments may not have been presented for a specific portion of the invention, or that further undescribed alternate embodiments may be available for a portion, is not to be considered a disclaimer of those alternate embodiments. One of ordinary skill will appreciate that many of those undescribed embodiments incorporate the same principles of the invention as claimed and others are equivalent.

1. A method comprising:
receiving an indication that a viewer of a video stream on a device has selected a tagged area of the video corresponding to an article of clothing appearing in the video while the video is playing;
using a computer,
i) accessing and retrieving from an avatar-related storage stored information needed to construct an avatar for the viewer dimensioned in proportion to physical dimensions of the viewer based upon an avatar identifier for the viewer,
ii) accessing and retrieving from a tag related storage sizing information regarding the article of clothing corresponding to the tagged area that is sufficient to allow the article of clothing to be displayed on the avatar, and appear to fit the avatar in proportion to how a physical specimen of the article of clothing would fit the viewer, and
iii) changing the sizing information contained in the tag related storage independently of the tagged area in the video; and
displaying to the viewer on the device the avatar for the viewer wearing the proportionally fitted article of clothing.

2. The method of claim 1, further comprising:
receiving an indication from the viewer, following the displaying, that will trigger a purchase by the viewer of the article of clothing displayed on the avatar.

3. The method of claim 1, further comprising:
using the computer, retrieving information identifying a vendor for the article of clothing corresponding to the tagged area; and
initiating a communication by the viewer to the vendor, the communication identifying the article of clothing and payment information so that the vendor can consummate the viewer's purchase of the article of clothing.

4. The method of claim 1, further comprising:
determining that an alteration must be made to the article of clothing based upon the stored information needed to construct the avatar for the viewer dimensioned in proportion to physical dimensions of the viewer and the sizing information regarding the article of clothing.

5. The method of claim 3, wherein the vendor is one of multiple vendors applicable to different regional user locations, and the information identifying the vendor is based upon regional location information.

6. The method of claim 1, wherein the displaying to the viewer comprises, displaying the avatar to the viewer while the video continues to play and be displayed to the viewer.

7. The method of claim 2, wherein, following receiving the indication from the viewer that will trigger the purchase by the viewer, the method comprises requesting payment information from the viewer.

8. The method of claim 7, further comprising:
receiving payment information from the viewer.

9. The method of claim 8, further comprising:
initiating a communication with a vendor identifying the article of clothing and the payment information so that the vendor can consummate the viewer's purchase of the article of clothing.

10. The method of claim 1, further comprising: maintaining the stored information needed to construct the avatar for the viewer dimensioned in proportion to the physical dimensions of the viewer in a database such that the viewer can change at least one value representing at least one dimension of the viewer.

11. An apparatus comprising:
an Enterprise System Bus (ESB) platform including a processor, memory, tag-related storage and avatar-related storage,
the tag-related storage including information stored therein correlating selectable areas in a video with items of clothing appearing in the video, the tag-related storage providing for storage of details regarding the items of clothing, the tag-related storage further providing for changing the details independently of the information correlating the selectable areas in the video with the items of clothing appearing in the video,
the avatar-related storage including information stored therein, provided by a specific user and representing the specific user's actual physical measurements, that is usable by the ESB platform to construct an avatar for the specific user that is proportionally dimensioned to the actual physical measurements;
the ESB platform being constructed to, in response to receiving an indication that the specific user has made a selection of a specific selectable area of the video, the ESB platform will
(i) retrieve the details regarding an item of clothing corresponding to the specific selectable area of the video based upon the information stored in the tag related storage,
(ii) retrieve the information from the avatar-related storage,
(iii) use the details and the retrieved information to construct a clothed avatar for the specific user with the clothed avatar wearing the item of clothing such that a depicted version of the item of clothing on the avatar will fit the avatar in proportion to how the item of clothing will fit the actual physical measurements of the specific user, and
(iv) display the clothed avatar to the specific user.

12. The apparatus of claim 11, further comprising an interface via which the ESB platform receives the details regarding an item of clothing for storage in the tag related storage.

13. The apparatus of claim 11, further comprising an interface via which the ESB platform can provide payment information to a vendor of the item of clothing.

14. The apparatus of claim 11, wherein the ESB platform is constructed to tag the video so as to define the selectable areas.
